(19) United States
(12) Patent Application Publication
(10) Pub. No.: US 2026/0056707 A1
(43) Pub. Date: Feb. 26, 2026

(54) FILE MERGING METHOD AND DEVICE FOR REAL-TIME DATA LAKE, AND STORAGE MEDIUM

(71) Applicant: Beijing Volcano Engine Technology Co., Ltd., Beijing (CN)

(72) Inventors: Wei Liu, Beijing (CN); Yanghao Lin, Beijing (CN); Zhongjia Wei, Beijing (CN); Yakun Li, Beijing (CN)

(21) Appl. No.: 19/263,787

(22) Filed: Jul. 9, 2025

(30) Foreign Application Priority Data
Aug. 21, 2024 (CN) 202411155688.0

(51) Int. Cl. G06F 7/14; G06F 16/14

(52) U.S. Cl. CPC G06F 7/14; G06F 16/148

(57) ABSTRACT

Embodiments of the present disclosure provide a file merging method for a real-time data lake, a device and a storage medium. The method comprises: obtaining characteristic information of a query task for a real-time data lake table and attribute information of files to be merged in the real-time data lake table; determining, based on the characteristic information of the query task and the attribute information of the files to be merged, whether to initiate a merging task; and in accordance with a determination that the merging task is initiated, merging the files to be merged.

### CROSS-REFERENCE TO RELATED APPLICATION(S)

This application claims priority to Chinese Application No. 202411155688.0 filed Aug. 21, 2024, the disclosure of which is incorporated herein by reference in its entirety.

### FIELD

Embodiments of the present disclosure relate to the technical field of computer and network communication, and in particular, to a file merging method and device for a real-time data lake, and a storage medium.

### BACKGROUND

The real-time data lake is a data storage and processing architecture, which is intended to solve the problem of managing and analyzing massive data. Based on distributed storage and computing technologies, a large amount of data that is generated in real time can be received and processed.

### SUMMARY

Embodiments of the present disclosure provide a file merging method and device for a real-time data lake, and a storage medium, so as to determine a file merging timing for a real-time data lake table, reduce a user cost, and improve query performance.

In a first aspect, an embodiment of the present disclosure provides a file merging method for a real-time data lake, comprising:
obtaining characteristic information of a query task for a real-time data lake table and attribute information of files to be merged in the real-time data lake table;
determining, based on the characteristic information of the query task and the attribute information of the files to be merged, whether to initiate a merging task; and
in accordance with a determination that the merging task is initiated, merging the files to be merged.

In a second aspect, an embodiment of the present disclosure provides a file merging device for a real-time data lake, comprising:
an obtaining unit, configured to obtain characteristic information of a query task for a real-time data lake table and attribute information of files to be merged in the real-time data lake table;
a determining unit, configured to determine, based on the characteristic information of the query task and the attribute information of the files to be merged, whether to initiate a merging task; and
an executing unit, configured to: in accordance with a determination that the merging task is initiated, merge the files to be merged.

In a third aspect, an embodiment of the present disclosure provides an electronic device, comprising: at least one processor and a memory;
where the memory has computer-executable instructions stored therein; and
the at least one processor executes the computer-executable instructions stored in the memory to cause the at least one processor to perform the file merging method for a real-time data lake according to the first aspect above and various possible designs of the first aspect.

In a fourth aspect, an embodiment of the present disclosure provides a computer-readable storage medium having computer-executable instructions stored therein, where the file merging method for a real-time data lake according to the first aspect above and various possible designs of the first aspect is implemented when a processor executes the computer-executable instructions.

In a fifth aspect, an embodiment of the present disclosure provides a computer program product, including computer-executable instructions, where the file merging method for a real-time data lake according to the first aspect above and various possible designs of the first aspect is implemented when a processor executes the computer-executable instructions.

A file merging method and device for a real-time data lake, and the storage medium provided in the embodiments of the present disclosure, by obtaining the characteristic information of the query task for the real-time data lake table and the attribute information of the files to be merged in the real-time data lake table, predicting the overhead of the query task in the case that the files to be merged are not merged and the overhead of the query task and the merging task in the case that the files to be merged are merged, and then selecting a solution with a smaller overhead, the file merging timing can be determined for the real-time data lake table scientifically and rationally in the embodiments of the present disclosure, thereby reducing the user cost and improving the query performance.

### BRIEF DESCRIPTION OF THE DRAWINGS

In order to illustrate the technical solutions in the embodiments of the present disclosure or in the prior art more clearly, the drawings for describing the embodiments or the prior art will be briefly described in the following. Apparently, the drawings in the following description show some embodiments of the present disclosure, and those of ordinary skill in the art may still derive other drawings from these drawings without creative efforts.

FIG. 1 is an exemplary diagram of file merging for a real-time data lake in the prior art;

FIG. 2 is a flowchart of a file merging method for a real-time data lake provided by an embodiment of the present disclosure;

FIG. 3 is a flowchart of a file merging method for a real-time data lake provided by another embodiment of the present disclosure;

FIG. 4 is an exemplary diagram of file merging provided by an embodiment of the present disclosure;

FIG. 5 is a structural block diagram of a file merging device for a real-time data lake provided by an embodiment of the present disclosure; and

FIG. 6 is a schematic diagram of a hardware structure of an electronic device provided by an embodiment of the present disclosure.

### DETAILED DESCRIPTION OF EMBODIMENTS

In the prior art, for small files in a real-time data lake table, file merging is usually performed in a fixed period, but this may affect query performance, or may bring unnecessary resource overhead to a user, thereby increasing the cost.

In order to make the objectives, technical solutions, and advantages of the embodiments of the present disclosure clearer, the technical solutions in the embodiments of the present disclosure will be described clearly and comprehensively in conjunction with the drawings in the embodiments of the present disclosure. Obviously, the described embodiments are part of the embodiments of the present disclosure, but not all of them. Based on the embodiments in the present disclosure, all other embodiments obtained by those of ordinary skill in the art without creative effort shall fall within the protection scope of the present disclosure.

The real-time data lake is a data storage and processing architecture, which is intended to solve the problem of managing and analyzing massive data. Based on distributed storage and computing technologies, a large amount of data that is generated in real time can be received and processed.

In the scenario of a real-time data lake, data written to a real-time data lake table is usually written into a memory first, and then committed to a disk incrementally, that is, incremental data is stored in a disk in the form of incremental files. For example, data of a certain target object in a data lake table is modified for the first time, and data of the target object after the first modification is written into the memory and then committed to the disk, and saved in an incremental file 1 in the disk; then, the data of the target object is modified for the second time, and data of the target object after the second modification is written into the memory and then committed to the disk, and saved in an incremental file 2 in the disk. As time increases, there are more and more incremental files, and the amount of data in the incremental files is generally relatively small. In particular, these incremental files and stock files may include data of different versions of the same object. If these incremental files are not compact with the stock files in time, the performance of subsequent real-time query operations will be affected, resulting in performance degradation.

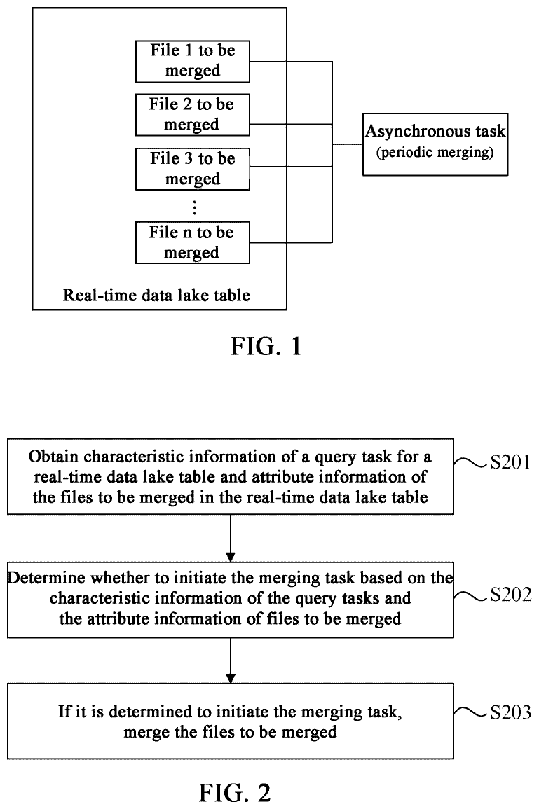

In the prior art, for an incremental file in a real-time data lake table, an asynchronous task is usually configured to perform file merging by adopting a fixed period. As shown in FIG. 1, in the prior art, for stock files and incremental files to be merged in a real-time data lake table: files to be merged 1, 2, 3 . . . n, the asynchronous task is adopted to perform merging according to a preset fixed time period.

However, performing file merging by the asynchronous task adopting the fixed period may affect query performance, or may bring unnecessary resource overhead to a user, thereby increasing the cost. The specific reasons are as follows:
1) The writing of data streams in the real-time data lake is not uniform. In a scenario where the writing speed of data streams is relatively large, if the file merging is performed by adopting the fixed period and the fixed period is too long, it may cause too many small files to be piled up, thereby affecting the query performance;
2) In a scenario where the writing speed of data streams is relatively small, if the file merging is performed by adopting the fixed period and the fixed period is too short, it may lead to that there are not many small files needing to be merged every time, and the merging task is too frequent, while each merging task also has resource overhead, thereby increasing unnecessary cost; and
3) Performing file merging can improve the query performance, reduce the resource overhead of the query task, and reduce the cost of the query task; but at the same time, the file merging also increases the resource overhead and the cost of the merging task, and for the customer, how to optimize the cost to the greatest extent is an urgent problem to be solved.

In view of the above problems, the present disclosure provides a file merging method for a real-time data lake, in which whether to initiate a merging task for files to be merged is determined through characteristic information of a query task and attribute information of the files to be merged, and the determination basis is to predict the overhead of the query task in a case that the files to be merged are not merged and the overhead of the query task and the merging task in a case that the files to be merged are merged, and then a solution with a smaller overhead is selected, thereby reducing the user cost and improving the query performance.

The file merging method for a real-time data lake of the present disclosure will be described in detail below with reference to specific embodiments.

Referring to FIG. 2, FIG. 2 is a flowchart of a file merging method for a real-time data lake provided by an embodiment of the present disclosure. The method of this embodiment can be applied to an electronic device such as a server. The file merging method for a real-time data lake comprises the following.

S201, characteristic information of a query task for a real-time data lake table and attribute information of files to be merged in the real-time data lake table are obtained.

In this embodiment, in order to optimize the cost, it is necessary to determine the timing of initiating the merging task scientifically and reasonably, and the timing of initiating the merging task is related to specific conditions of the query task and the merging task. In this embodiment, the characteristic information of the query task for the real-time data lake table and the attribute information of the files to be merged in the real-time data lake table may be obtained, so as to measure the specific conditions of the query task and the merging task. Among them, the files to be merged may include stock files and incremental files of the real-time data lake table in a disk.

In this embodiment, the query task may refer to a task of querying target data from the files to be merged in the real-time data lake table based on a specific query condition. For example, data of a certain target object is queried. The embodiments of the present disclosure do not limit the query content of the query task. The query task may be initiated directly and actively by a user, or may be initiated automatically in a process of providing a service of a business function for the user, or may be initiated based on a requirement of a background system of the service of the business function.

The merging task may refer to merging the files to be merged by adopting a preset rule, so as to reduce the quantity and data volume of the files to be merged. The preset rule may be merging according to category, source or timeliness, which is not limited in this embodiment.

Optionally, the characteristic information of the query task may refer to task information of a historical query task for the real-time data lake table, and for example, may include but is not limited to a query frequency, a resource allocation volume, and a duration of any historical query task, where the resource allocation volume may refer to computer resources occupied in a process of the query task, and the computer resources may include a CPU usage, a memory usage, a disk usage, and the like. Optionally, the characteristic information of the query task may be obtained from a task management center, that is, the task management center saves the characteristic information of the query task after creating the query task every time for subsequent use. Certainly, the characteristic information of the query task may also be obtained by any other feasible way, which is not limited here.

Optionally, the attribute information of the files to be merged may include but is not limited to a size, a type, and the like of the files to be merged. Optionally, in this embodiment, the attribute information of the files to be merged may be gathered by scanning the files to be merged, or the attribute information of the files to be merged may be obtained in other manners.

Optionally, the attribute information of the files to be merged may be obtained through a preset metadata center, where the metadata center has the attribute information of the files to be merged pre-stored therein, and the attribute information of the files to be merged may be written into the metadata center as metadata when the files to be merged are persisted to the disk. Certainly, the metadata center may also determine the location of each of the files to be merged, and then count the quantity and data volume of the files to be merged.

Optionally, the metadata center in this embodiment may support real-time data lakes of different forms, and may provide storage and management of metadata for the real-time data lakes of different forms. When any implementation data lake generates a small file, that is, the file to be merged, its file attribute information is written into the metadata center as metadata, and then when it is necessary to obtain the attribute information of the file to be merged, it may be directly obtained from the metadata center.

In specific implementation, any real-time data lake, such as a real-time data lake based on iceberg (an open table format), may support hive catalog (providing access and management of Hive metadata), hadoop catalog (metadata management in Hadoop ecosystem), restcatalog (providing a unified API to manage metadata), etc. Considering that the storage location of metadata in different forms is different, for example, the hive catalog is stored in hms (Hive Metastore, Hive metadata management) by default, the Hadoop catalog is stored in file storage by default, and the rest catalog is stored in user-defined backend storage, resulting in the metadata being scattered in different locations, which may result in failure to accurately obtain the metadata. Therefore, in this embodiment, a metadata center is provided, which can provide storage and management of metadata for real-time data lakes of different forms, is compatible with the hive protocol, and provides http&thrift (network communication protocol) services externally. The electronic device will be notified asynchronously every time data is written, so as to keep a view, thereby ensuring the accuracy of the metadata.

S202, whether to initiate a merging task is determined based on the characteristic information of the query task and the attribute information of the files to be merged.

In this embodiment, based on the acquisition of the characteristic information of the query task for the real-time data lake table and the attribute information of the files to be merged in the real-time data lake table, the specific conditions of the query task and the merging task can be measured, and the cost in different cases can be predicted and compared, so as to determine whether to initiate the merging task with the goal of optimizing the cost.

Optionally, the electronic device may predict the overhead of the query task in the case that the files to be merged are not merged and the overhead of the query task and the merging task in the case that the files to be merged are merged, based on the characteristic information of the query task and the attribute information of the files to be merged, so as to determine whether to initiate the merging task.

Specifically, determining, based on the characteristic information of the query task and the attribute information of the files to be merged, whether to initiate a merging task comprises:
predicting, based on the characteristic information of the query task and the attribute information of the files to be merged, a first resource overhead indicator of the query task in a case that the files to be merged are not merged and a second resource overhead indicator of the query task and the merging task in a case that the files to be merged are merged; and
determining, based on the first resource overhead indicator and the second resource overhead indicator, whether to initiate the merging task.

In this embodiment, the electronic device predicts, based on the characteristic information of the query task and the attribute information of the files to be merged, the first resource overhead indicator of the query task in the case that the files to be merged are not merged and the second resource overhead indicator of the query task and the merging task in the case that the files to be merged are merged, so that the first resource overhead indicator and the second resource overhead indicator can be compared, thereby determining whether to initiate the merging task better, and achieving the objectives of reducing the cost and improving the query performance.

Among them, the first resource overhead indicator and the second resource overhead indicator may refer to parameters for quantifying overheads, which facilitates the comparison between the first resource overhead indicator and the second resource overhead indicator.

S203, in accordance with a determination that the merging task is initiated, the files to be merged are merged.

In this embodiment, in accordance with the determination that the merging task is initiated, the execution of the merging task may be started, that is, the files to be merged are merged by adopting the preset rule, so as to reduce the quantity and data volume of the files to be merged, where the preset rule may be merging according to category, source or timeliness, which is not limited in the present disclosure.

In specific implementation, the files to be merged may be extracted from the disk into a memory, the merging operation is performed in the memory to obtain merged files, and then the merged files are returned to the disk.

According to the file merging method for a real-time data lake provided by the present disclosure, by obtaining the characteristic information of the query task for the real-time data lake table and the attribute information of the files to be merged in the real-time data lake table, predicting the overhead of the query task in the case that the files to be merged are not merged and the overhead of the query task and the merging task in the case that the files to be merged are merged, and then selecting a solution with a smaller overhead, the file merging timing can be determined for the real-time data lake table scientifically and rationally, thereby reducing the user cost and improving the query performance.

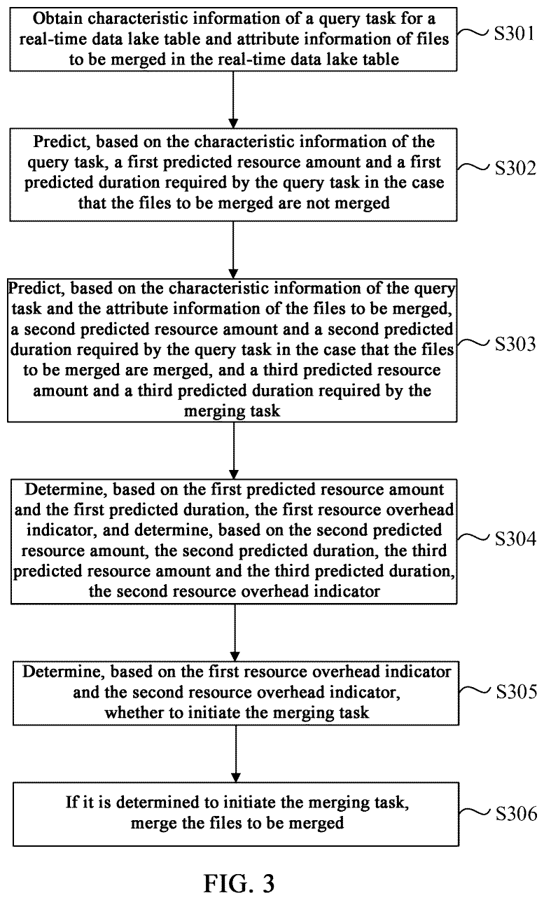

Referring to FIG. 3, FIG. 3 is a flowchart of a file merging method for a real-time data lake provided by another embodiment of the present disclosure. The method of this embodiment can be applied to an electronic device or a server. The file merging method for a real-time data lake comprises the following.

S301, characteristic information of a query task for a real-time data lake table and attribute information of files to be merged in the real-time data lake table are obtained.

S302, a first predicted resource amount and a first predicted duration required by the query task in a case that the files to be merged are not merged are predicted based on the characteristic information of the query task.

Among them, in the real-time data lake scenario, since data streams are continuously written into the real-time data lake table, small files, that is, files to be merged, will be continuously generated, resulting in the increase of the resource allocation volume and duration of the next query task. Assuming that the generation speed of the files to be merged does not change abruptly, the change of the resource allocation volume and duration of each query task can be considered to conform to a certain change rule. Therefore, in the case that the file merging is not performed, the first predicted resource amount and the first predicted duration of the query task can be predicted based on the resource allocation volume and duration of the historical query task.

For example, in the case that the file merging is not performed, the resource allocation volume of the Nth historical query task is a, and the query duration is b; the resource allocation volume of the (N+1)th historical query task is a+1, and the query duration is b+2; and the resource allocation volume of the (N+2)th historical query task is a+2, and the query duration is b+4. According to the above change trend, it can be predicted that the resource allocation volume of the (N+3)th historical query task is a+3, and the query duration is b+6.

Optionally, when predicting the first predicted resource amount and the first predicted duration of the query task in the case that the files to be merged are not merged based on the resource allocation volume and duration of the historical query task in the case that the file merging is not performed, it may be assumed that the change trend of the first predicted resource amount and the first predicted duration is linear. As in the above example, a linear regression algorithm may be adopted to determine the linear change rule of the resource allocation volume and duration of the historical query task based on the characteristic information of the query task, especially the resource allocation volume and duration of the historical query task, and then the first predicted resource amount and the first predicted duration are predicted.

Optionally, a preset prediction model may also be adopted to learn the characteristic information of the query task, so as to learn the linear change rule of the resource allocation volume and duration of the historical query task, and then predict the first predicted resource amount and the first predicted duration, where the preset prediction model may be any possible model, such as a neural network model.

Certainly, in this embodiment, any other possible methods may also be adopted to predict the first predicted resource amount and the first predicted duration required by the query task in the case that the files to be merged are not merged based on the characteristic information of the query task, which is not limited here.

S303, a second predicted resource amount and a second predicted duration required by the query task in a case that the files to be merged are merged, and a third predicted resource amount and a third predicted duration required by the merging task are predicted based on the characteristic information of the query task and the attribute information of the files to be merged.

In this embodiment, the quantity and data volume of merged files after the current files to be merged are merged may be determined based on the characteristic information of the query task and the attribute information of the files to be merged, and then the second predicted resource amount and the second predicted duration required by the query task for the merged files in the case that the files to be merged are merged may be predicted based on the quantity and data volume of the merged files and the characteristic information of the query task.

Among them, the characteristic information of the query task may further include the resource allocation volume and duration of the historical query task in the case that the file merging is performed, and may further include the quantity and data volume of historical merged files, that is, the quantity and data volume of files when the historical query task is executed in the case that the file merging is performed.

Among them, in the case that the file merging is performed, the change of the resource allocation volume and duration of the historical query task can be considered to conform to a certain change rule under a specific quantity and data volume of files. Therefore, in the case that the file merging is performed, the change rule among the quantity and data volume of the historical merged files, the resource allocation volume and the duration of the historical query task is determined, which can then be used to predict the second predicted resource amount and the second predicted duration required by the query task for the merged files in the case that the files to be merged are merged this time.

For example, in the case that the file merging is performed, the resource allocation volume of the Nth historical query task is a, the query duration is b, the quantity of files when the Nth historical query task is executed is h, and the data volume is i; and in the case that the files to be merged are merged this time, the quantity of merged files is g1, and the data volume is g2; and then the second predicted resource amount and the second predicted duration required by the query task for the merged files in the case that the files to be merged are merged this time can be predicted.

Optionally, it may be assumed that in the case that the file merging is performed, the change rule among the quantity and data volume of the historical merged files, the resource allocation volume and the duration of the historical query task is determined to be a linear rule. Therefore, the linear regression algorithm may be adopted to predict the second predicted resource amount and the second predicted duration required by the query task for the merged files in the case that the files to be merged are merged this time, based on the quantity and data volume of the historical merged files, the resource allocation volume and the duration of the historical query task, and the quantity and data volume of the merged files this time.

Optionally, a preset prediction model may also be adopted to learn the change rule among the quantity and data volume of the historical merged files, the resource allocation volume and the duration of the historical query task, and then predict the second predicted resource amount and the second predicted duration required by the query task for the merged files in the case that the files to be merged are merged this time based on the quantity and data volume of the merged files this time, where the preset prediction model may be any possible model, such as a neural network model.

Certainly, in this embodiment, other possible methods may also be adopted to predict the second predicted resource amount and the second predicted duration required by the query task for the merged files in the case that the files to be merged are merged this time, which is not limited here.

In addition, when determining the quantity and data volume of the merged files after the current files to be merged are merged, the quantity and data volume of the merged files after the current files to be merged are merged may be predicted by a corresponding relationship between a first quantity and a first data volume before the historical merging task and a second quantity and a second data volume after the historical merging task.

For example, the first quantity of files before the historical merging task M1 is merged is d1, the first data volume is d2, the second quantity of files after the historical merging task M1 is merged is e1, and the second data volume is e2; the first quantity of files before the historical merging task M2 is merged is d3, the first data volume is d4, the second quantity of files after the historical merging task M2 is merged is e3, and the second data volume is e4; the quantity of current files to be merged is f1, and the data volume of the files to be merged is f2; the quantity of the merged files after the files to be merged that need to be predicted are merged is g1, and the data volume is g2. In an optional solution, it may be assumed that the change rule of the quantity and data volume of the files before and after the merging task is merged presents a linear relationship. Therefore, g1 and g2 may be obtained according to d1/e1−f1/g1, d2/e2−f2/g2; alternatively, an interpolation algorithm may also be adopted to construct (d1−d3)/(e1−e3)=(d3−f1)/(e3−g1), (d2−d4)/(e2−e4)−(d4−f2)/(e4−g2), to obtain g1 and g2.

In addition, the third predicted resource amount and the third predicted duration required by the merging task may also be predicted according to the attribute information of the files to be merged. On the basis that the attribute information of the files to be merged (including the quantity and data volume of the files to be merged) is known, optionally, the third predicted resource amount and the third predicted duration required by the merging task this time may be predicted according to a preset rule or preset empirical information.

Optionally, the third predicted resource amount and the third predicted duration required by the merging task this time may also be predicted according to the resource amount and duration of the historical merging task (the quantity and data volume of files before and after the merging are known). Specifically, it may be assumed that the change rule among the resource amount and duration of the historical merging task, the quantity and data volume of files before and after the merging is linear. Therefore, the linear regression algorithm may be adopted to predict the third predicted resource amount and the third predicted duration required by the merging task this time according to the resource amount and duration of the historical merging task, the quantity and data volume of files before and after the merging, and the quantity and data volume of the files to be merged this time.

Optionally, a preset prediction model may also be adopted to learn the change rule among the resource amount and duration of the historical merging task, the quantity and data volume of files before and after the merging, and then predict the third predicted resource amount and the third predicted duration required by the merging task this time according to the quantity and data volume of the files to be merged this time, where the preset prediction model may be any possible model, such as a neural network model.

S304, the first resource overhead indicator is determined based on the first predicted resource amount and the first predicted duration, and the second resource overhead indicator is determined based on the second predicted resource amount, the second predicted duration, the third predicted resource amount and the third predicted duration.

In this embodiment, after the first predicted resource amount and the first predicted duration required by the query task in the case that the files to be merged are not merged are determined, the first resource overhead indicator of the query task in the case that the files to be merged are not merged may be determined based on the first predicted resource amount and the first predicted duration. After the second predicted resource amount and the second predicted duration required by the query task in the case that the files to be merged are merged and the third predicted resource amount and the third predicted duration required by the merging task are determined, the second resource overhead indicator of the query task and the merging task in the case that the files to be merged are merged may be determined based on the second predicted resource amount, the second predicted duration, the third predicted resource amount and the third predicted duration. It should be noted that the specific forms of the first resource overhead indicator and the second resource overhead indicator are not limited in this embodiment, as long as the first resource overhead indicator and the second resource overhead indicator are comparable, for example, the first resource overhead indicator and the second resource overhead indicator may be expressed in combination with resource prices.

In a possible implementation, the method for determining the first resource overhead indicator and the second resource overhead indicator may comprises:

obtaining a first product between the first predicted resource amount and the first predicted duration, and determining the first product as the first resource overhead indicator; and

obtaining a second product between the second predicted resource amount and the second predicted duration and a third product between the third predicted resource amount and the third predicted duration, and determining a sum of the second product and the third product as the second resource overhead indicator.

In the embodiments of the present disclosure, the larger the amount of resources used, the greater the resource overhead; the longer the query time, the greater the resource overhead. Therefore, the product of the resource amount and the duration is used as the resource overhead indicator, which can more accurately quantify the first resource overhead indicator and the second resource overhead indicator.

The specific formula may be as follows:

$$first resource overhead indicator = C 1 * T 1 ;$$

$$second resource overhead indicator = C 2 * T 2 + C 3 * T 3 ;$$

where C1 is the first predicted resource amount required by the query task in the case that the files to be merged are not merged, and T1 is the first predicted duration required by the query task in the case that the files to be merged are not merged; C2 is the second predicted resource amount required by the query task in the case that the files to be merged are merged, and T2 is the second predicted duration required by the query task in the case that the files to be merged are merged; C3 is the third predicted resource amount required by the merging task, and T3 is the third predicted duration required by the merging task.

In another possible implementation, the method for determining the first resource overhead indicator and the second resource overhead indicator may comprises:
obtaining a fourth product between the first predicted resource amount, the first predicted duration and the query frequency of the query task, and determining the fourth product as the first resource overhead indicator.
obtaining a fifth product between the second predicted resource amount, the second predicted duration and the query frequency of the query task and a sixth product between the third predicted resource amount and the third predicted duration, and determining a sum of the fifth product and the sixth product as the second resource overhead indicator.

In the embodiments of the present disclosure, when the query frequency is greater than 1, since the overhead of each query task increases successively, the query frequency is multiplied with the first product and the second product, respectively, and the first product and the second product are amplified according to the query frequency, so that the obtained first resource overhead indicator and second resource overhead indicator are more accurate (certainly, when the query frequency is 1, that is, it is equivalent to the above implementation).

The specific formula may be as follows:

$$first resource overhead indicator = C 1 * T 1 * F ;$$

$$second resource overhead indicator = C 2 * T 2 * F + C 3 * T 3 ;$$

where F is the query frequency of the query task.

In the case of a periodic query task, by comparing the magnitude of the first resource overhead indicator and the second resource overhead indicator, the user cost is reduced. On the other hand, after the merging, the quantity and data volume of files in the query task during querying can be reduced, thereby improving the query performance.

In S305, whether to initiate the merging task is determined based on the first resource overhead indicator and the second resource overhead indicator.

Specifically, if the first resource overhead indicator is greater than the second resource overhead indicator, initiating the merging task is determined. Alternatively, if a ratio of the first resource overhead indicator to the second resource overhead indicator is greater than a preset threshold, initiating the merging task is determined.

The preset threshold may be adjusted according to the requirements of the user, so that the merging frequency of the merging task can be adjusted.

S306, in accordance with a determination that the merging task is initiated, the files to be merged are merged.

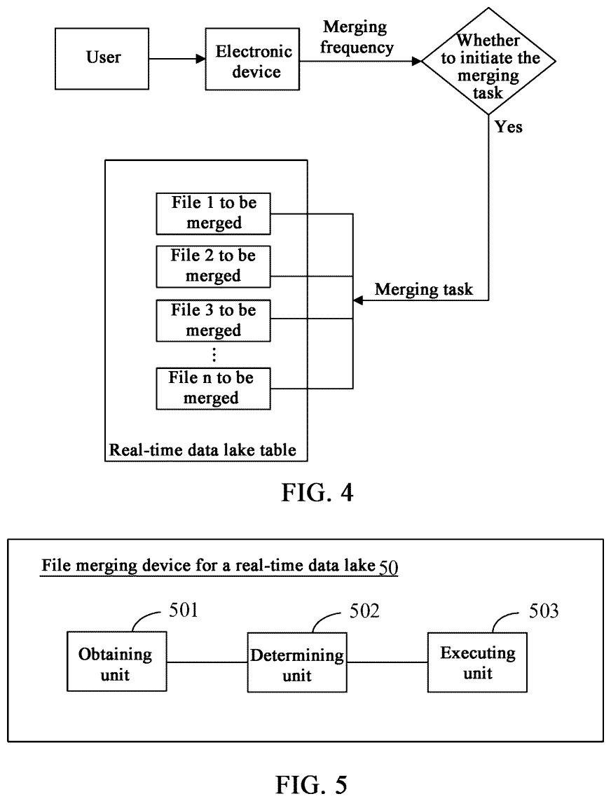

Referring to FIG. 4, FIG. 4 is an exemplary diagram of file merging provided by an embodiment of the present disclosure. The user configures the file merging method for a real-time data lake and a preset merging frequency into the electronic device according to requirements of the real-time data lake table, where the preset merging frequency is a frequency of determining whether to initiate the merging task, for example, the determination is performed once per second. The electronic device triggers the determination of the merging task according to the preset merging frequency. If it is determined that the merging task is initiated, small files in the real-time data lake table are merged; if it is determined that the merging task is not initiated, the small files in the real-time data lake table are not merged.

According to the file merging method for a real-time data lake provided in another embodiment of the present disclosure, the characteristic information of the query task for the real-time data lake table and the attribute information of the files to be merged in the real-time data lake table are obtained, so as to predict the first predicted resource amount and the first predicted duration required by the query task in the case that the files to be merged are not merged, the second predicted resource amount and the second predicted duration required by the query task in the case that the files to be merged are merged, and the third predicted resource amount and the third predicted duration required by the merging task, then the first resource overhead indicator is determined based on the first predicted resource amount and the first predicted duration, and the second resource overhead indicator is determined based on the second predicted resource amount, the second predicted duration, the third predicted resource amount and the third predicted duration, and finally whether to initiate the merging task is determined based on the magnitude of the first resource overhead indicator and the second resource overhead indicator. The resource overhead and duration before and after the merging task are considered comprehensively, which improves the flexibility of the merging task, reduces the user cost, and improves the query performance.

Corresponding to the file merging method for a real-time data lake in the above embodiment, FIG. 5 is a structural block diagram of a file merging device for a real-time data lake provided by an embodiment of the present disclosure. For ease of explanation, only parts related to the embodiments of the present disclosure are shown. Referring to FIG. 5, the device 50 includes: a obtaining unit 501, a determining unit 502, and an executing unit 503, where:
the obtaining unit 501 is configured to obtain characteristic information of a query task for a real-time data lake table and attribute information of files to be merged in the real-time data lake table;
the determining unit 502 is configured to determine, based on the characteristic information of the query task and the attribute information of the files to be merged, whether to initiate a merging task; and
the executing unit 503 is configured to: in accordance with a determination that the merging task is initiated, merge the files to be merged.

In one or more embodiments of the present disclosure, the determining unit 502 is further configured to:
predict, based on the characteristic information of the query task and the attribute information of the files to be merged, a first resource overhead indicator of the query task in a case that the files to be merged are not merged and a second resource overhead indicator of the query task and the merging task in a case that the files to be merged are merged; and
determine, based on the first resource overhead indicator and the second resource overhead indicator, whether to initiate the merging task.

In one or more embodiments of the present disclosure, the determining unit 502 is further configured to:
predict, based on the characteristic information of the query task, a first predicted resource amount and a first predicted duration required by the query task in a case that the files to be merged are not merged;
predict, based on the characteristic information of the query task and the attribute information of the files to be merged, a second predicted resource amount and a second predicted duration required by the query task in a case that the files to be merged are merged, and a third predicted resource amount and a third predicted duration required by the merging task; and
determine the first resource overhead indicator based on the first predicted resource amount and the first predicted duration, and determine the second resource overhead indicator based on the second predicted resource amount, the second predicted duration, the third predicted resource amount and the third predicted duration.

In one or more embodiments of the present disclosure, the determining unit 502 is further configured to:
obtain a first product between the first predicted resource amount and the first predicted duration, and determine the first product as the first resource overhead indicator; and
obtain a second product between the second predicted resource amount and the second predicted duration and a third product between the third predicted resource amount and the third predicted duration, and determine a sum of the second product and the third product as the second resource overhead indicator.

In one or more embodiments of the present disclosure, the determining unit 502 is further configured to:
obtain a fourth product between the first predicted resource amount, the first predicted duration and the query frequency of the query task, and determine the fourth product as the first resource overhead indicator; and
obtain a fifth product between the second predicted resource amount, the second predicted duration and the query frequency of the query task and a sixth product between the third predicted resource amount and the third predicted duration, and determine a sum of the fifth product and the sixth product as the second resource overhead indicator.

In one or more embodiments of the present disclosure, the determining unit 502 is further configured to:
adopt a linear regression algorithm or a preset prediction model to predict, based on the characteristic information of the query task, the first predicted resource amount and the first predicted duration required by the query task in the case that the files to be merged are not merged; and
adopt the linear regression algorithm or the preset prediction model to predict, based on the characteristic information of the query task and the attribute information of the files to be merged, the second predicted resource amount and the second predicted duration required by the query task in the case that the files to be merged are merged, and the third predicted resource amount and the third predicted duration required by the merging task.

In one or more embodiments of the present disclosure, the determining unit 502 is further configured to:
in accordance with a determination that the first resource overhead indicator is greater than the second resource overhead indicator, determine to initiate the merging task; or
in accordance with a determination that a ratio of the first resource overhead indicator to the second resource overhead indicator is greater than a preset threshold, determine to initiate the merging task.

The device provided in this embodiment can be used to implement the technical solutions of the above method embodiments, and the implementation principles and technical effects thereof are similar, which will not be repeated in this embodiment.

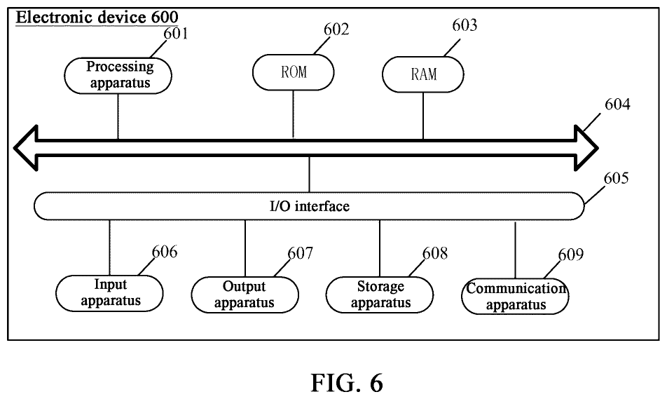

Referring to FIG. 6, it shows a schematic structural diagram of an electronic device 600 suitable for implementing the embodiments of the present disclosure, and the electronic device 600 may be a terminal device or a server. The terminal device may include, but is not limited to, a mobile terminal such as a mobile phone, a notebook computer, a digital broadcast receiver, a personal digital assistant (abbreviated as PDA), a tablet computer, a portable media player (abbreviated as PMP), a vehicle-mounted terminal (such as a vehicle-mounted navigation terminal), etc., and a fixed terminal such as a digital TV, a desktop computer, etc. The electronic device shown in FIG. 6 is only an example, and should not bring any limitation to the function and usage scope of the embodiments of the present disclosure.

As shown in FIG. 6, the electronic device 600 may include a processing apparatus (such as a central processing unit, a graphics processor, etc.) 601, which can perform various appropriate actions and processing according to a program stored in a read only memory (Read Only Memory, ROM for short) 902 or a program loaded from a storage apparatus 608 into a random access memory (Random Access Memory, RAM for short) 603. The RAM 603 also stores various programs and data necessary for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touch pad, a keyboard, a mouse, a camera, a microphone, an accelerometer, a gyroscope, etc.; an output apparatus 607 including, for example, a liquid crystal display (Liquid Crystal Display, LCD for short), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 having various apparatuses, it should be understood that not all of the illustrated apparatuses are required to be implemented or provided. More or fewer apparatuses may be implemented or provided instead.

In particular, according to the embodiments of the present disclosure, the process described above with reference to the flowchart may be implemented as a computer software program. For example, an embodiment of the present disclosure includes a computer program product, which includes a computer program carried on a computer-readable medium, and the computer program contains program codes for executing the method shown in the flowchart. In such an embodiment, the computer program may be downloaded from a network through the communication apparatus 609 and installed, or installed from the storage apparatus 608, or installed from the ROM 602. When the computer program is executed by the processing apparatus 601, the above-mentioned functions defined in the methods of the embodiments of the present disclosure are executed.

It should be noted that the above-mentioned computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, a computer-readable storage medium may be any tangible medium that contains or stores a program that may be used by or in combination with an instruction execution system, apparatus or device. In the present disclosure, a computer-readable signal medium may include a data signal that propagates in a baseband or as a part of a carrier wave, and carries computer-readable program codes. Such propagated data signals can take a variety of forms, including but not limited to electromagnetic signals, optical signals, or any suitable combination thereof. The computer-readable signal medium may also be any computer-readable medium other than the computer-readable storage medium. The computer-readable signal medium may send, propagate, or transmit a program for use by or in combination with an instruction execution system, apparatus, or device. The program codes contained in the computer-readable medium may be transmitted by any suitable medium, including but not limited to: wire, optical cable, RF (radio frequency), etc., or any suitable combination thereof.

The above computer-readable medium may be included in the above electronic device; or may also exist alone without being assembled into the electronic device.

The above computer-readable medium carries one or more programs, and when the above one or more programs are executed by the electronic device, the electronic device is caused to execute the method shown in the above embodiments.

The computer program codes for executing the operations of the present disclosure may be written in one or more programming languages or a combination thereof. The above-mentioned programming languages include object-oriented programming languages such as Java, Smalltalk, C++, and also include conventional procedural programming languages such as “C” or similar programming languages. The program code may be executed entirely on the user's computer, partly executed on the user's computer, executed as a stand-alone software package, partly executed on the user's computer and partly executed on a remote computer, or entirely executed on the remote computer or server. In the case involving the remote computer, the remote computer may be connected to the user's computer through any type of network, including a local area network (LAN for short) or a wide area network (WAN for short), or the connection may be made to an external computer (for example, through the Internet using an Internet service provider).

The flowcharts and block diagrams in the drawings illustrate the architecture, functionality, and operation of possible implementations of the systems, methods, and computer program products according to various embodiments of the present disclosure. In this regard, each block in the flowcharts or block diagrams may represent a module, program segment, or part of codes, and the module, program segment, or part of codes contains one or more executable instructions for implementing specified logical functions. It should also be noted that, in some alternative implementations, the functions marked in the blocks may also occur in an order different from those marked in the drawings. For example, two blocks shown in succession can actually be executed substantially in parallel, or they can sometimes be executed in a reverse order, depending on the functions involved. It should also be noted that each block in the block diagrams and/or flowcharts and the combination of blocks in the block diagrams and/or flowcharts may be implemented by a dedicated hardware-based system that performs the specified functions or operations, or may be implemented by a combination of dedicated hardware and computer instructions.

The units involved in the embodiments described in the present disclosure may be implemented in software or hardware. The name of the unit does not constitute a limitation of the unit itself under certain circumstances. For example, the first acquiring unit may also be described as “a unit for acquiring at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

In a first aspect, according to one or more embodiments of the present disclosure, there is provided a file merging method for a real-time data lake, comprising:
obtaining characteristic information of a query task for a real-time data lake table and attribute information of files to be merged in the real-time data lake table;
determining, based on the characteristic information of the query task and the attribute information of the files to be merged, whether to initiate a merging task; and
in accordance with a determination that the merging task is initiated, merging the files to be merged.

According to one or more embodiments of the present disclosure, the determining, based on the characteristic information of the query task and the attribute information of the files to be merged, whether to initiate a merging task includes:
predicting, based on the characteristic information of the query task and the attribute information of the files to be merged, a first resource overhead indicator of the query task in a case that the files to be merged are not merged and a second resource overhead indicator of the query task and the merging task in a case that the files to be merged are merged; and
determining, based on the first resource overhead indicator and the second resource overhead indicator, whether to initiate the merging task.

According to one or more embodiments of the present disclosure, the predicting, based on the characteristic information of the query task and the attribute information of the files to be merged, a first resource overhead indicator of the query task in a case that the files to be merged are not merged and a second resource overhead indicator of the query task and the merging task in a case that the files to be merged are merged comprises:
predicting, based on the characteristic information of the query task, a first predicted resource amount and a first predicted duration required by the query task in a case that the files to be merged are not merged;
predicting, based on the characteristic information of the query task and the attribute information of the files to be merged, a second predicted resource amount and a second predicted duration required by the query task in a case that the files to be merged are merged, and a third predicted resource amount and a third predicted duration required by the merging task; and
determining the first resource overhead indicator based on the first predicted resource amount and the first predicted duration, and determining the second resource overhead indicator based on the second predicted resource amount, the second predicted duration, the third predicted resource amount and the third predicted duration.

According to one or more embodiments of the present disclosure, determining the first resource overhead indicator based on the first predicted resource amount and the first predicted duration includes:
obtaining a first product between the first predicted resource amount and the first predicted duration, and determining the first product as the first resource overhead indicator; and
determining the second resource overhead indicator based on the second predicted resource amount, the second predicted duration, the third predicted resource amount and the third predicted duration comprises:
obtaining a second product between the second predicted resource amount and the second predicted duration and a third product between the third predicted resource amount and the third predicted duration, and determining a sum of the second product and the third product as the second resource overhead indicator.

According to one or more embodiments of the present disclosure, determining the first resource overhead indicator based on the first predicted resource amount and the first predicted duration comprises:
obtaining a fourth product between the first predicted resource amount, the first predicted duration and the query frequency of the query task, and determining the fourth product as the first resource overhead indicator; and
determining the second resource overhead indicator based on the second predicted resource amount, the second predicted duration, the third predicted resource amount and the third predicted duration comprises:
obtaining a fifth product between the second predicted resource amount, the second predicted duration and the query frequency of the query task and a sixth product between the third predicted resource amount and the third predicted duration, and determining a sum of the fifth product and the sixth product as the second resource overhead indicator.

According to one or more embodiments of the present disclosure, the characteristic information of the query task includes one or more of: resource allocation volume and duration of multiple historical query tasks, and query frequency of the historical query task; and
the attribute information of the files to be merged includes one or more of: quantity and data volume of the files to be merged.

According to one or more embodiments of the present disclosure, predicting, based on the characteristic information of the query task, the first predicted resource amount and the first predicted duration required by the query task in the case that the files to be merged are not merged comprises:
adopting a linear regression algorithm or a preset prediction model to predict, based on the characteristic information of the query task, the first predicted resource amount and the first predicted duration required by the query task in the case that the files to be merged are not merged; and
predicting, based on the characteristic information of the query task and the attribute information of the files to be merged, the second predicted resource amount and the second predicted duration required by the query task in the case that the files to be merged are merged, and the third predicted resource amount and the third predicted duration required by the merging task comprises:
adopting the linear regression algorithm or the preset prediction model to predict, based on the characteristic information of the query task and the attribute information of the files to be merged, the second predicted resource amount and the second predicted duration required by the query task in the case that the files to be merged are merged, and the third predicted resource amount and the third predicted duration required by the merging task.

According to one or more embodiments of the present disclosure, determining, based on the first resource overhead indicator and the second resource overhead indicator, whether to initiate the merging task comprises:
in accordance with a determination that the first resource overhead indicator is greater than the second resource overhead indicator, determining to initiate the merging task; or
in accordance with a determination that a ratio of the first resource overhead indicator to the second resource overhead indicator is greater than a preset threshold, determining to initiate the merging task.

In a second aspect, according to one or more embodiments of the present disclosure, there is provided a file merging device for a real-time data lake, comprising:
an obtaining unit configured to obtain characteristic information of a query task for a real-time data lake table and attribute information of files to be merged in the real-time data lake table;
a determining unit configured to determine, based on the characteristic information of the query task and the attribute information of the files to be merged, whether to initiate a merging task; and
an executing unit configured to: in accordance with a determination that the merging task is initiated, merge the files to be merged.

According to one or more embodiments of the present disclosure, the determining unit 502 is further configured to:
predict, based on the characteristic information of the query task and the attribute information of the files to be merged, a first resource overhead indicator of the query task in a case that the files to be merged are not merged and a second resource overhead indicator of the query task and the merging task in a case that the files to be merged are merged; and
determine, based on the first resource overhead indicator and the second resource overhead indicator, whether to initiate the merging task.

According to one or more embodiments of the present disclosure, the determining unit 502 is further configured to:
predict, based on the characteristic information of the query task, a first predicted resource amount and a first predicted duration required by the query task in a case that the files to be merged are not merged;
predict, based on the characteristic information of the query task and the attribute information of the files to be merged, a second predicted resource amount and a second predicted duration required by the query task in a case where the files to be merged are merged, and a third predicted resource amount and a third predicted duration required by the merging task; and
determine the first resource overhead indicator based on the first predicted resource amount and the first predicted duration, and determine the second resource overhead indicator based on the second predicted resource amount, the second predicted duration, the third predicted resource amount and the third predicted duration.

In one or more embodiments of the present disclosure, the determining unit 502 is further configured to:
obtain a first product between the first predicted resource amount and the first predicted duration, and determine the first product as the first resource overhead indicator; and
obtain a second product between the second predicted resource amount and the second predicted duration and a third product between the third predicted resource amount and the third predicted duration, and determine a sum of the second product and the third product as the second resource overhead indicator.

In one or more embodiments of the present disclosure, the determining unit 502 is further configured to:
obtain a fourth product between the first predicted resource amount, the first predicted duration and the query frequency of the query task, and determine the fourth product as the first resource overhead indicator; and
obtain a fifth product between the second predicted resource amount, the second predicted duration and the query frequency of the query task and a sixth product between the third predicted resource amount and the third predicted duration, and determine a sum of the fifth product and the sixth product as the second resource overhead indicator.

In one or more embodiments of the present disclosure, the determining unit 502 is further configured to:
adopt a linear regression algorithm or a preset prediction model to predict, based on the characteristic information of the query task, the first predicted resource amount and the first predicted duration required by the query task in the case that the files to be merged are not merged; and
adopt the linear regression algorithm or the preset prediction model to predict, based on the characteristic information of the query task and the attribute information of the files to be merged, the second predicted resource amount and the second predicted duration required by the query task in the case that the files to be merged are merged, and the third predicted resource amount and the third predicted duration required by the merging task.

In one or more embodiments of the present disclosure, the determining unit 502 is further configured to:
in accordance with a determination that the first resource overhead indicator is greater than the second resource overhead indicator, determine to initiate the merging task; or
in accordance with a determination that a ratio of the first resource overhead indicator to the second resource overhead indicator is greater than a preset threshold, determine to initiate the merging task.

In a third aspect, according to one or more embodiments of the present disclosure, there is provided an electronic device, including: at least one processor and a memory, where
the memory stores computer-executable instructions; and
the at least one processor executes the computer-executable instructions stored in the memory, causing the at least one processor to execute the file merging method for a real-time data lake according to the above first aspect and various possible designs of the first aspect.

In a fourth aspect, according to one or more embodiments of the present disclosure, there is provided a computer-readable storage medium, where the computer-readable storage medium stores computer-executable instructions, and when a processor executes the computer-executable instructions, the file merging method for a real-time data lake according to the above first aspect and various possible designs of the first aspect is implemented.

In a fifth aspect, according to one or more embodiments of the present disclosure, there is provided a computer program product, including computer-executable instructions, and when a processor executes the computer-executable instructions, the file merging method for a real-time data lake according to the above first aspect and various possible designs of the first aspect is implemented.

The above description is only preferred embodiments of the present disclosure and an illustration of applied technical principles. Those skilled in the art should understand that the disclosure scope involved in the present disclosure is not limited to the technical solutions formed by the specific combination of the above technical features, and should also cover other technical solutions formed by any combination of the above technical features or equivalent features thereof without departing from the above disclosure concept. For example, the technical solutions formed by replacing the above features with technical features with similar functions disclosed in the present disclosure (but not limited to).

In addition, although operations are depicted in a specific order, this should not be understood as requiring these operations to be performed in the specific order shown or in a sequential order. Under certain circumstances, multitasking and parallel processing may be advantageous. Similarly, although the above discussion contains several specific implementation details, these should not be construed as limiting the scope of the present disclosure. Certain features that are described in the context of separate embodiments may also be implemented in combination in a single embodiment. On the contrary, various features described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only exemplary forms of implementing the claims.

I/We claim:

1. A file merging method for a real-time data lake, comprising:
obtaining characteristic information of a query task for a real-time data lake table and attribute information of files to be merged in the real-time data lake table;
determining, based on the characteristic information of the query task and the attribute information of the files to be merged, whether to initiate a merging task; and
in accordance with a determination that the merging task is initiated, merging the files to be merged.

2. The method according to claim 1, wherein determining, based on the characteristic information of the query task and the attribute information of the files to be merged, whether to initiate the merging task comprises:
predicting, based on the characteristic information of the query task and the attribute information of the files to be merged, a first resource overhead indicator of the query task in a case that the files to be merged are not merged and a second resource overhead indicator of the query task and the merging task in a case that the files to be merged are merged; and
determining, based on the first resource overhead indicator and the second resource overhead indicator, whether to initiate the merging task.

3. The method according to claim 2, wherein predicting, based on the characteristic information of the query task and the attribute information of the files to be merged, the first resource overhead indicator of the query task in the case that the files to be merged are not merged and the second resource overhead indicator of the query task and the merging task in the case that the files to be merged are merged comprises:
predicting, based on the characteristic information of the query task, a first predicted resource amount and a first predicted duration required by the query task in the case that the files to be merged are not merged;
predicting, based on the characteristic information of the query task and the attribute information of the files to be merged, a second predicted resource amount and a second predicted duration required by the query task in the case that the files to be merged are merged, and a third predicted resource amount and a third predicted duration required by the merging task; and
determining, based on the first predicted resource amount and the first predicted duration, the first resource overhead indicator, and determining, based on the second predicted resource amount, the second predicted duration, the third predicted resource amount and the third predicted duration, the second resource overhead indicator.

4. The method according to claim 3, wherein determining, based on the first predicted resource amount and the first predicted duration, the first resource overhead indicator comprises:
obtaining a first product between the first predicted resource amount and the first predicted duration, and determining the first product as the first resource overhead indicator; and
wherein determining, based on the second predicted resource amount, the second predicted duration, the third predicted resource amount and the third predicted duration, the second resource overhead indicator comprises:
obtaining a second product between the second predicted resource amount and the second predicted duration and a third product between the third predicted resource amount and the third predicted duration, and determining a sum of the second product and the third product as the second resource overhead indicator.

5. The method according to claim 3, wherein determining, based on the first predicted resource amount and the first predicted duration, the first resource overhead indicator comprises:
obtaining a fourth product between the first predicted resource amount, the first predicted duration and query frequency of the query task, and determining the fourth product as the first resource overhead indicator; and
wherein determining, based on the second predicted resource amount, the second predicted duration, the third predicted resource amount and the third predicted duration, the second resource overhead indicator comprises:
obtaining a fifth product between the second predicted resource amount, the second predicted duration and the query frequency of the query task and a sixth product between the third predicted resource amount and the third predicted duration, and determining a sum of the fifth product and the sixth product as the second resource overhead indicator.

6. The method according to claim 3, wherein the characteristic information of the query task comprises one or more of: resource allocation volume and duration of a plurality of historical query tasks, and query frequency of the historical query task; and
the attribute information of the files to be merged comprises one or more of: quantity and data volume of the files to be merged.

7. The method according to claim 6, wherein predicting, based on the characteristic information of the query task, the first predicted resource amount and the first predicted duration required by the query task in the case that the files to be merged are not merged comprises:
predicting, using a linear regression algorithm or a preset prediction model and based on the characteristic information of the query task, the first predicted resource amount and the first predicted duration required by the query task in the case that the files to be merged are not merged; and
wherein predicting, based on the characteristic information of the query task and the attribute information of the files to be merged, the second predicted resource amount and the second predicted duration required by the query task in the case that the files to be merged are merged, and the third predicted resource amount and the third predicted duration required by the merging task comprises:
predicting, using the linear regression algorithm or the preset prediction model, and based on the characteristic information of the query task and the attribute information of the files to be merged, the second predicted resource amount and the second predicted duration required by the query task in the case that the files to be merged are merged, and the third predicted resource amount and the third predicted duration required by the merging task.

8. The method according to claim 2, wherein determining, based on the first resource overhead indicator and the second resource overhead indicator, whether to initiate the merging task comprises:
in accordance with a determination that the first resource overhead indicator is greater than the second resource overhead indicator, initiating the merging task; or
in accordance with a determination that a ratio of the first resource overhead indicator to the second resource overhead indicator is greater than a preset threshold, initiating the merging task.

9. An electronic device, comprising: at least one processor and a memory, wherein
the memory stores computer-executable instructions; and
the computer-executable instructions stored in the memory, when executed by the at least one processor, causing the at least one processor to:
obtain characteristic information of a query task for a real-time data lake table and attribute information of files to be merged in the real-time data lake table;
determine, based on the characteristic information of the query task and the attribute information of the files to be merged, whether to initiate a merging task; and
in accordance with a determination that the merging task is initiated, merge the files to be merged.

10. The electronic device according to claim 9, wherein the computer-executable instructions causing the at least one processor to determine, based on the characteristic information of the query task and the attribute information of the files to be merged, whether to initiate the merging task comprise instructions to:
predict, based on the characteristic information of the query task and the attribute information of the files to be merged, a first resource overhead indicator of the query task in a case that the files to be merged are not merged and a second resource overhead indicator of the query task and the merging task in a case that the files to be merged are merged; and
determine, based on the first resource overhead indicator and the second resource overhead indicator, whether to initiate the merging task.

11. The electronic device according to claim 10, wherein the computer-executable instructions causing the at least one processor to predict, based on the characteristic information of the query task and the attribute information of the files to be merged, the first resource overhead indicator of the query task in the case that the files to be merged are not merged and the second resource overhead indicator of the query task and the merging task in the case that the files to be merged are merged comprise instructions to:
predict, based on the characteristic information of the query task, a first predicted resource amount and a first predicted duration required by the query task in the case that the files to be merged are not merged;
predict, based on the characteristic information of the query task and the attribute information of the files to be merged, a second predicted resource amount and a second predicted duration required by the query task in the case that the files to be merged are merged, and a third predicted resource amount and a third predicted duration required by the merging task; and
determine, based on the first predicted resource amount and the first predicted duration, the first resource overhead indicator, and determine, based on the second predicted resource amount, the second predicted duration, the third predicted resource amount and the third predicted duration, the second resource overhead indicator.

12. The electronic device according to claim 11, wherein the computer-executable instructions causing the at least one processor to determine, based on the first predicted resource amount and the first predicted duration, the first resource overhead indicator comprise instructions to:
obtain a first product between the first predicted resource amount and the first predicted duration, and determine the first product as the first resource overhead indicator; and
wherein determining, based on the second predicted resource amount, the second predicted duration, the third predicted resource amount and the third predicted duration, the second resource overhead indicator comprises:
obtaining a second product between the second predicted resource amount and the second predicted duration and a third product between the third predicted resource amount and the third predicted duration, and determining a sum of the second product and the third product as the second resource overhead indicator.

13. The electronic device according to claim 11, wherein the computer-executable instructions causing the at least one processor to determine, based on the first predicted resource amount and the first predicted duration, the first resource overhead indicator comprise instructions to:
obtain a fourth product between the first predicted resource amount, the first predicted duration and query frequency of the query task, and determine the fourth product as the first resource overhead indicator; and
wherein determining, based on the second predicted resource amount, the second predicted duration, the third predicted resource amount and the third predicted duration, the second resource overhead indicator comprises:
obtaining a fifth product between the second predicted resource amount, the second predicted duration and the query frequency of the query task and a sixth product between the third predicted resource amount and the third predicted duration, and determining a sum of the fifth product and the sixth product as the second resource overhead indicator.

14. The electronic device according to claim 11, wherein the characteristic information of the query task comprises one or more of: resource allocation volume and duration of a plurality of historical query tasks, and query frequency of the historical query task; and
the attribute information of the files to be merged comprises one or more of: quantity and data volume of the files to be merged.

15. The electronic device according to claim 14, wherein the computer-executable instructions causing the at least one processor to predict, based on the characteristic information of the query task, the first predicted resource amount and the first predicted duration required by the query task in the case that the files to be merged are not merged comprise instructions to:
predict, using a linear regression algorithm or a preset prediction model and based on the characteristic information of the query task, the first predicted resource amount and the first predicted duration required by the query task in the case that the files to be merged are not merged; and
wherein predicting, based on the characteristic information of the query task and the attribute information of the files to be merged, the second predicted resource amount and the second predicted duration required by the query task in the case that the files to be merged are merged, and the third predicted resource amount and the third predicted duration required by the merging task comprises:
predicting, using the linear regression algorithm or the preset prediction model, and based on the characteristic information of the query task and the attribute information of the files to be merged, the second predicted resource amount and the second predicted duration required by the query task in the case that the files to be merged are merged, and the third predicted resource amount and the third predicted duration required by the merging task.

16. The electronic device according to claim 10, wherein the computer-executable instructions causing the at least one processor to determine, based on the first resource overhead indicator and the second resource overhead indicator, whether to initiate the merging task comprise instructions to:
in accordance with a determination that the first resource overhead indicator is greater than the second resource overhead indicator, initiate the merging task; or
in accordance with a determination that a ratio of the first resource overhead indicator to the second resource overhead indicator is greater than a preset threshold, initiate the merging task.

17. A non-transitory computer-readable storage medium, wherein the computer-readable storage medium stores computer-executable instructions, and the computer-executable instructions, when executed by a processor, cause the processor to:
obtain characteristic information of a query task for a real-time data lake table and attribute information of files to be merged in the real-time data lake table;
determine, based on the characteristic information of the query task and the attribute information of the files to be merged, whether to initiate a merging task; and
in accordance with a determination that the merging task is initiated, merge the files to be merged.

18. The storage medium according to claim 17, wherein the computer-executable instructions causing the processor to determine, based on the characteristic information of the query task and the attribute information of the files to be merged, whether to initiate the merging task comprise instructions to:
predict, based on the characteristic information of the query task and the attribute information of the files to be merged, a first resource overhead indicator of the query task in a case that the files to be merged are not merged and a second resource overhead indicator of the query task and the merging task in a case that the files to be merged are merged; and
determine, based on the first resource overhead indicator and the second resource overhead indicator, whether to initiate the merging task.

19. The storage medium according to claim 18, wherein the computer-executable instructions causing the processor to predict, based on the characteristic information of the query task and the attribute information of the files to be merged, the first resource overhead indicator of the query task in the case that the files to be merged are not merged and the second resource overhead indicator of the query task and the merging task in the case that the files to be merged are merged comprise instructions to:
predict, based on the characteristic information of the query task, a first predicted resource amount and a first predicted duration required by the query task in the case that the files to be merged are not merged;
predict, based on the characteristic information of the query task and the attribute information of the files to be merged, a second predicted resource amount and a second predicted duration required by the query task in the case that the files to be merged are merged, and a third predicted resource amount and a third predicted duration required by the merging task; and
determine, based on the first predicted resource amount and the first predicted duration, the first resource overhead indicator, and determine, based on the second predicted resource amount, the second predicted duration, the third predicted resource amount and the third predicted duration, the second resource overhead indicator.

20. The storage medium according to claim 19, wherein the computer-executable instructions causing the at least one processor to determine, based on the first predicted resource amount and the first predicted duration, the first resource overhead indicator comprise instructions to:
obtain a first product between the first predicted resource amount and the first predicted duration, and determine the first product as the first resource overhead indicator; and
wherein determining, based on the second predicted resource amount, the second predicted duration, the third predicted resource amount and the third predicted duration, the second resource overhead indicator comprises:
obtaining a second product between the second predicted resource amount and the second predicted duration and a third product between the third predicted resource amount and the third predicted duration, and determining a sum of the second product and the third product as the second resource overhead indicator.
